(19) United States
(12) Patent Application Publication
(10) Pub. No.: US 2026/0087743 A1
(43) Pub. Date: Mar. 26, 2026

(54) SYSTEMS AND METHODS FOR LOD GENERATION FOR CLOTHING OBJECTS

(71) Applicant: Electronic Arts Inc., Redwood City, CA (US)

(72) Inventors: Ashton MASON, Brighton (GB); Lenna ZHU, Shanghai (CN)

(73) Assignee: Electronic Arts Inc., Redwood City, CA (US)

(21) Appl. No.: 18/897,954

(22) Filed: Sep. 26, 2024

(51) Int. Cl. G06T 17/20; G06T 15/08

(52) U.S. Cl. CPC G06T 17/205; G06T 15/08; G06T 2210/16; G06T 2210/36

(57) ABSTRACT

Generating a simplified mesh is disclosed, comprising: receiving an input mesh associated with an outer bound mesh and an inner bound mesh, where each vertex of the input mesh is located outside the outer bound mesh and inside the inner bound mesh; performing one or more mesh simplification operations on the input mesh to generate a level-of-detail (LOD) mesh corresponding to the input mesh; determining that a first vertex of the LOD mesh is located outside the outer bound mesh or inside the inner bound mesh; determining a bound vector for the first vertex that binds the first vertex to the outer bound mesh or inner bound mesh; and generating an updated LOD mesh based on moving the first vertex based on the bound vector, wherein the first vertex in the updated LOD mesh is located inside the outer bound mesh and outside the inner bound mesh.

### TECHNICAL FIELD

This disclosure generally relates to computer graphics and, more particularly, to systems and methods for generating Levels of Detail (LODs) for clothing objects.

### BACKGROUND

For three-dimensional (3D) graphics applications, such as video games or animated films, efficient processing of data by reducing computational complexity of a given operation is often useful. This is particularly the case in real-time applications, such as video games.

Various operations can be performed using computer-generated objects in a scene. An object may be represented as a polygonal mesh, which comprises a collection of vertices, edges, and faces that define the shape and/or boundary of the object.

One technique to reduce the computational complexity of a given graphics operation involving a 3D object is to use a lower complexity stand-in for the 3D object. For 3D objects that comprise a polygonal mesh, mesh simplification can be performed on the 3D object to produce simplified versions of the polygonal mesh called Levels of Detail (LODs). For example, a LOD can be used as a stand-in for the original (full-resolution model) in-game when the modelled 3D object is far from the camera and thus small on screen.

Polygonal meshes can be simplified by edge collapse to generate LODs, where an edge in a mesh is replaced with a single vertex in the simplified mesh. Some mesh simplification methods collapse single edges at each pass. Other mesh simplification methods collapse multiple edges at once in what is called polychord collapse, allowing the simplified mesh to preserve the grid-like topology of semi-regular quad mesh models that are often used in games.

Generating LODs for clothing models is challenging due to the complex structure of clothing models, which can include many sub-meshes, open ends, and different combinations of clothing models layered on one another. Most mesh simplification systems operate on a single mesh with no knowledge of any other objects or meshes, which can result in clipping within or between LODs of layered clothing models. For example, a portion of a t-shirt LOD that is layered beneath a jacket LOD may protrude outside the jacket LOD, causing an artifact. This is a common issue in games where the LODs of clothing models do not match the original models or other clothing layers.

Accordingly, there remains a need in the art for an improved system and method for generating Levels of Detail (LODs) for clothing objects.

### SUMMARY

Embodiments of the disclosure provide a method, device, and computer-readable storage medium for generating a simplified mesh. The method includes: receiving an input mesh, wherein the input mesh is a polygonal mesh, wherein the input mesh is associated with an outer bound mesh and an inner bound mesh, wherein each vertex of the input mesh is located inside the outer bound mesh and outside the inner bound mesh; performing one or more mesh simplification (for example, edge collapse) operations on the input mesh to generate a level-of-detail (LOD) mesh corresponding to the input mesh; for a first vertex of the LOD mesh, determining that the first vertex is located outside the outer bound mesh or inside the inner bound mesh; determining a bound vector for the first vertex that binds the first vertex to the outer bound mesh when the first vertex is located outside the outer bound mesh or binds the first vertex to the inner bound mesh when the first vertex is located inside the inner bound mesh; and generating an updated LOD mesh based on moving the first vertex based on the bound vector, wherein the first vertex in the updated LOD mesh is located inside the outer bound mesh and outside the inner bound mesh.

### BRIEF DESCRIPTION OF THE DRAWINGS

FIG. 1 is a block diagram of a computer system for rendering images, according to aspects of the present disclosure.

FIG. 2 is a block diagram illustrating processor and buffer interaction, according to one embodiment.

FIG. 3 is an example of a polygonal mesh, according to one embodiment.

FIG. 4 is an exploded view of the object defined by the polygonal mesh shown in FIG. 3, according to one embodiment.

FIG. 5 is an example of a level-of-detail mesh corresponding to the polygonal mesh in FIG. 3, according to one embodiment.

FIG. 6 is a conceptual diagram illustrating edge collapse, according to one embodiment.

FIG. 7 is a conceptual diagram illustrating polychord collapse, according to one embodiment.

FIG. 8 illustrates a self-intersecting polychord, in one embodiment.

FIG. 9 illustrates clothing meshes, in one embodiment.

FIG. 10 illustrates LODs of clothing objects, in one embodiment.

FIG. 11 illustrates an inner bound mesh and an outer bound mesh for a t-shirt object, according to one embodiment.

FIG. 12 is an example of LODs of an inner bound mesh and an outer bound mesh, in one embodiment.

FIG. 13 illustrates voxelized versions of an inner bound mesh and an outer bound mesh, in some embodiments.

FIG. 14 is a conceptual diagram illustrating signed distance fields (SDFs) for a voxelized inner bound mesh and a voxelized inner bound mesh, according to one embodiment.

FIG. 15 is a conceptual diagram illustrating a cross-section of an inner bound mesh and an outer bound mesh, in one embodiment.

FIG. 16 illustrates an example of a vertex outside an outer bound mesh that should be moved to the bound, according to one embodiment.

FIG. 17 illustrates computed values for a vertex relative to an outer bound mesh and an inner bound mesh, in one embodiment.

FIG. 18 is a conceptual diagram illustrating a vector for moving vertices of a face, according to one embodiment.

FIG. 19 is a conceptual diagram illustrating a vector for moving vertices of an edge, according to one embodiment.

FIG. 20 is a conceptual diagram illustrating aggregating bound vectors to move vertices, in one embodiment.

FIG. 21 is a conceptual diagram illustrating bound vectors to move vertices in one time step, in one embodiment.

FIG. 22 is an example of a jacket mesh, in one embodiment.

FIG. 23 illustrates a surface normal and gradient vector for a vertex, according to one embodiment.

FIG. 24 illustrates a polygonal mesh illustrating a vertex, in one embodiment.

FIG. 25 illustrates a polygonal mesh illustrating a vertex after one time step, in one embodiment.

FIG. 26 is an example of a cap of an open sleeve of a clothing object, in one embodiment.

FIG. 27 is an example of a texture map for a vest object, in one embodiment.

FIG. 28 is a flow diagram of method steps for generating a simplified mesh, according to one embodiment.

### DETAILED DESCRIPTION

The following detailed description provides examples and is not intended to limit the disclosure or the application and uses of the disclosure. Furthermore, there is no intention to be bound by any expressed or implied theory presented in the preceding technical field, background, summary, brief description of the drawings, or the following detailed description.

Embodiments of the disclosure provide a system and method for generating Levels of Detail (LODs) for clothing objects.

As described, a three-dimensional (3D) asset, such as a character or clothing worn by the character in a game, includes a main graphics mesh hand-authored by an artist, plus a number of secondary meshes that are used for a variety of other purposes. These secondary meshes are often specialized or simplified versions of the primary graphics mesh. A classic example of secondary meshes are level-of-detail (LOD) meshes, which are simplified versions of the primary graphics mesh, with successively fewer triangles, used as stand-ins for the primary mesh when the model is far away.

In some implementations, to generate the LODs, a series of simplified versions of an input polygonal mesh is generated. The simplified versions can be generated using a variety of mesh simplification techniques in which individual edges of the mesh are collapsed iteratively to successively reduce the triangle count of the polygonal mesh. When an edge is collapsed, the edge is replaced with a single vertex, and any incident faces are updated accordingly. The vertex is placed so as to optimally approximate the original geometry in the patch of surrounding faces.

Embodiments of the disclosure provide a system and method that utilizes an inner bound mesh and an outer bound mesh to generate LODs for character clothing models to prevent clipping between clothing layers. According to some embodiments, the inner and outer bound meshes are closed meshes that describe regions of space within which different types of clothing should be kept. In some implementations, the inner and outer bound meshes are authored by artists to separate different layers of clothing.

As described in greater detail herein, some embodiments use the inner and outer bound meshes as a guide for the automatic generation of LODs for clothing models. In one implementation, a signed distance field (SDF) is generated for a vertex relative to each bound mesh and is used to indicate whether a vertex of a generated LOD is inside or outside the corresponding bound mesh. If a vertex is found to be outside a bound mesh, then a solver computes a gradient of the SDF for the vertex and moves the vertex of the LODs to a particular bound.

In some embodiments, to preserve the shape of the LOD model when vertices are moved, the system implements one or more smoothing operations, where a vector repositions each vertex towards its original relative position, in relation to the average position of its neighboring vertices. If the shaping vectors for this smoothing operation increase the error of the vertex with respect to any bound, they are nullified and not performed.

Also, in some embodiments, to address clipping at the openings of a mesh (e.g., neckline, hems, etc.), the system allows artists to mark such faces with special UV values, treating the vertices of these faces as unboundable and thus not checked against the bounds.

Taking the context of video games as an example, the display of a video game is generally a video sequence presented to a display device capable of displaying the video sequence. The video sequence typically comprises a plurality of frames. By showing frames in succession in sequence order, simulated objects appear to move. A game engine typically generates frames in real-time response to user input, so rendering time is often constrained.

As used herein, a “frame” refers to an image of the video sequence. In some systems, such as interleaved displays, the frame might comprise multiple fields or more complex constructs, but generally a frame can be thought of as a view into a computer-generated scene at a particular time or short time window. For example, with 60 frames-per-second video, if one frame represents the scene at t=0 seconds, then the next frame would represent the scene at t= 1/60 seconds. In some cases, a frame might represent the scene from t=0 seconds to t= 1/60 seconds, but in the simple case, the frame is a snapshot in time.

A “scene” comprises those simulated objects that are positioned in a world coordinate space within a view pyramid, view rectangular prism, or other shaped view space. In some approaches, the scene comprises all objects (that are not obscured by other objects) within a view pyramid defined by a view point and a view rectangle with boundaries being the perspective planes through the view point and each edge of the view rectangle, possibly truncated by a background.

The simulated objects can be generated entirely from mathematical models describing the shape of the objects (such as arms and a torso described by a set of plane and/or curve surfaces), generated from stored images (such as the face of a famous person), or a combination thereof. If a game engine (or more specifically, a rendering engine that is part of the game engine or used by the game engine) has data as to where each object or portion of an object is in a scene, the frame for that scene can be rendered using standard rendering techniques.

A scene may comprise several objects or entities with some of the objects or entities being animated, in that the objects or entities may appear to move either in response to game engine rules or user input. For example, in a basketball game, a character for one of the basketball players might shoot a basket in response to user input, while a defending player will attempt to block the shooter in response to logic that is part of the game rules (e.g., an artificial intelligence component of the game rules might include a rule that defenders block shots when a shot attempt is detected) and when the ball moves through the net, the net will move in response to the ball. The net is expected to be inanimate, but the players' movements are expected to be animated and natural-appearing. Animated objects are typically referred to herein generically as characters and, in specific examples, such as animation of a football, soccer, baseball, basketball, or other sports game, the characters are typically simulated players in the game. In many cases, the characters correspond to actual sports figures and those actual sports figures might have contributed motion capture data for use in animating their corresponding character. Players and characters might be nonhuman, simulated robots, or other character types.

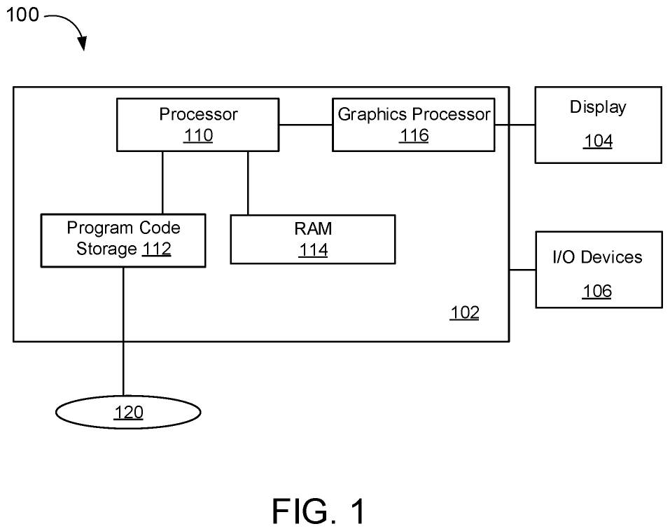

Turning to the drawings, FIG. 1 is a block diagram of a computer system 100 for rendering images, according to aspects of the present disclosure. The computer system 100 may be, for example, used for rendering images of a video game. The computer system 100 is shown comprising a console 102 coupled to a display 104 and input/output (I/O) devices 106. Console 102 is shown comprising a processor 110, program code storage 112, temporary data storage 114, and a graphics processor 116. Console 102 may be a handheld video game device, a video game console (e.g., special purpose computing device) for operating video games, a general-purpose laptop or desktop computer, or other suitable computing system, such as a mobile phone or tablet computer. Although shown as one processor in FIG. 1, processor 110 may include one or more processors having one or more processing cores. Similarly, although shown as one processor in FIG. 1, graphics processor 116 may include one or more processors having one or more processing cores.

Program code storage 112 may be ROM (read only-memory), RAM (random access memory), DRAM (dynamic random access memory), SRAM (static random access memory), hard disk, other magnetic storage, optical storage, other storage or a combination or variation of these storage device types. In some embodiments, a portion of the program code is stored in ROM that is programmable (e.g., ROM, PROM (programmable read-only memory), EPROM (erasable programmable read-only memory), EEPROM (electrically erasable programmable read-only memory), etc.) and a portion of the program code is stored on removable media such as a disc 120 (e.g., CD-ROM, DVD-ROM, etc.), or may be stored on a cartridge, memory chip, or the like, or obtained over a network or other electronic channel as needed. In some implementations, program code can be found embodied in a non-transitory computer-readable storage medium.

Temporary data storage 114 is usable to store variables and other game and processor data. In some embodiments, temporary data storage 114 is RAM and stores data that is generated during play of a video game, and portions thereof may also be reserved for frame buffers, depth buffers, polygon lists, texture storage, and/or other data needed or usable for rendering images as part of a video game presentation.

In one embodiment, I/O devices 106 are devices a user interacts with to play a video game or otherwise interact with console 102. I/O devices 106 may include any device for interacting with console 102, including but not limited to a video game controller, joystick, keyboard, mouse, keypad, VR (virtual reality) headset or device, etc.

Display 104 can any type of display device, including a television, computer monitor, laptop screen, mobile device screen, tablet screen, etc. In some embodiments, I/O devices 106 and display 104 comprise a common device, e.g., a touchscreen device. Still further, in some embodiments, one or more of the I/O devices 106 and display 104 is integrated in the console 102.

In various embodiments, since a video game is likely to be such that the particular image sequence presented on the display 104 depends on results of game instruction processing, and those game instructions likely depend, in turn, on user inputs, the console 102 (and the processor 110 and graphics processor 116) are configured to quickly process inputs and render a responsive image sequence in real-time or near real-time.

Various other components may be included in console 102, but are omitted for clarity. An example includes a networking device configured to connect the console 102 to a network, such as the Internet.

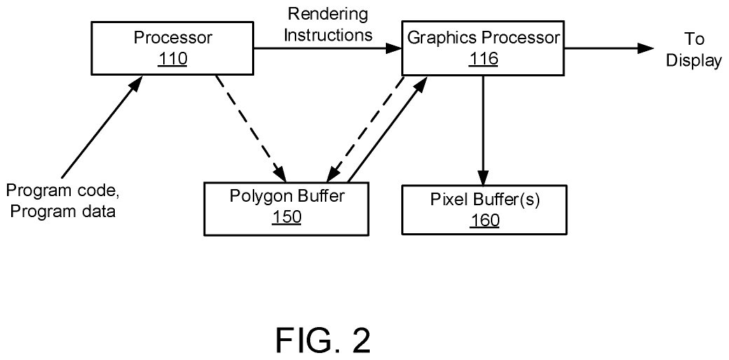

FIG. 2 is a block diagram illustrating processor and buffer interaction, according to one embodiment. As shown in FIG. 2, processor 110 executes program code and program data. In response to executing the program code, processor 110 outputs rendering instructions to graphics processor 116. Graphics processor 116, in turn, reads data from a polygon buffer 150 and interacts with pixel buffer(s) 160 to form an image sequence of one or more images that are output to a display. Alternatively, instead of sending rendering instructions to graphics processor 116 or in addition to sending rendering instructions to graphics processor 116, processor 110 may directly interact with polygon buffer 150. For example, processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. In some implementations, such high-level graphics commands might be those specified by the OpenGL specification, or those specified by a graphics processor manufacturer.

In one implementation of an image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. As such, a renderer processes a stream of polygons, even though the polygons may be read in place and be a finite set, where the number of polygons is known or determinable. For memory efficiency and speed, it may be preferable in some implementations that polygons be processed as a stream (as opposed to random access, or other ordering), so that fast, expensive memory used for polygons being processed is not required for all polygons comprising an image.

In some embodiments, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

In computer-generated visual content (such as interactive video games), objects may be represented by various computer-generated models, including polygonal meshes and texture maps. A polygonal mesh herein shall refer to a collection of vertices, edges, and faces that define the shape and/or boundaries of a three-dimensional object. A texture map herein shall refer to a projection of an image onto a corresponding polygonal mesh.

Texture mapping provides a method to map colors and other information to pixels from one or more 2D textures to a 3D surface of an object, analogous to “wrapping” a 2D image around the 3D object. In the advent of multi-pass rendering, texture mapping can also include more complex mappings, such as height mapping, bump mapping, normal mapping, displacement mapping, reflection mapping, specular mapping, occlusion mapping, and the like. These techniques make it possible to create near-photorealistic renderings of 3D objects.

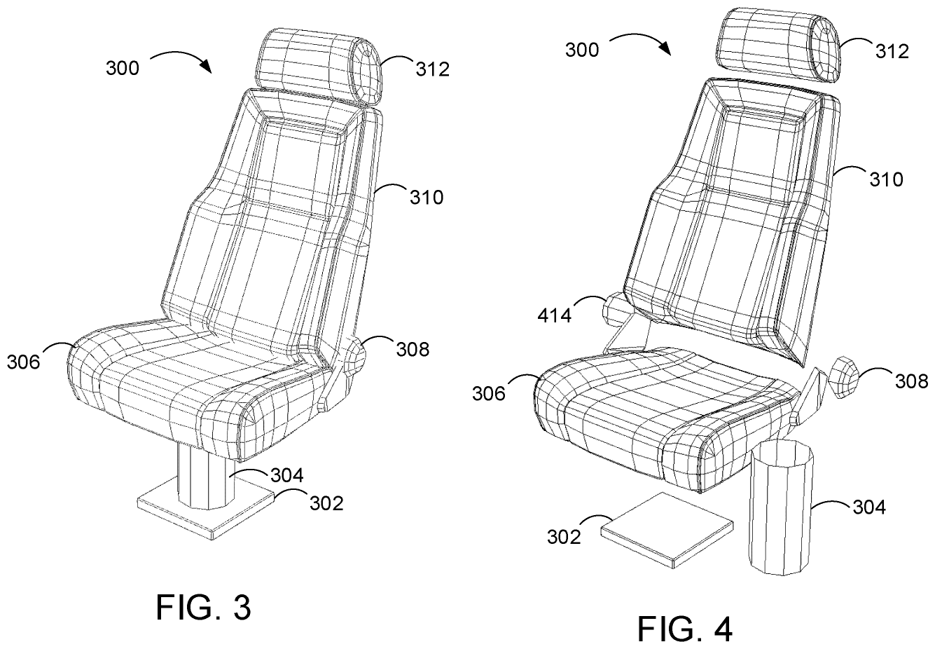

FIG. 3 is an example of a polygonal mesh 300, according to one embodiment. As described, the polygonal mesh 300 is a graphics mesh may correspond to an artist-authored object. In the example shown, the object represents a chair. The polygonal mesh 300 comprises a collection of vertices, edges, and faces that define the shape and/or boundary of the artist-authored object. The faces may include various polygonal shapes, such as triangles, quadrilaterals, convex polygons, concave polygons, regular polygons (e.g., polygons that may have equal length sides and may have equal angles) and/or irregular polygons (e.g., polygons that may not have equal length sides and may not have equal angles).

In various embodiments, the polygonal mesh 300 may be comprised of one or more polygonal sub-meshes, also called “components.” Each sub-mesh may include a series of polygons. In the example shown in FIG. 3, the polygonal mesh is comprised of multiple sub-meshes 302, 304, 306, 308, 310, 312, where sub-mesh 302 represents a chair base, sub-mesh 304 represents a chair post, sub-mesh 306 represents a chair seat, sub-mesh 308 represents a chair handle, sub-mesh 310 represents a chair back, and sub-mesh 312 represents a chair headrest.

FIG. 4 is an exploded view of the object defined by the polygonal mesh 300 shown in FIG. 3, according to one embodiment. The multiple sub-meshes or components are shown in FIG. 4, including sub-mesh 302 that represents a chair base, sub-mesh 304 that represents a chair post, sub-mesh 306 that represents a chair seat, sub-mesh 308 that represents a chair handle, sub-mesh 310 that represents a chair back, and sub-mesh 312 that represents a chair headrest. Also shown in FIG. 4 is a sub-mesh 414 that represents a second chair handle that is not visible in the perspective view shown in FIG. 3, as the second chair handle is occluded by the chair seat and chair back in FIG. 3.

As described above, one or more simplified polygonal meshes, or LODs, can be generated that represent the polygonal mesh 300 to be used in operations to reduce the computational complexity of the operations.

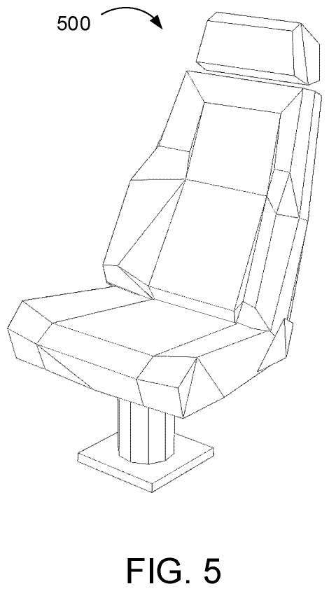

FIG. 5 is an example of a level-of-detail mesh (or LOD) 500 corresponding to the polygonal mesh 300 in FIG. 3, according to one embodiment. As shown, the LOD 500 is a polygonal mesh that includes a smaller number of faces, edges, and vertices compared to the polygonal mesh 300 in FIG. 3. In some implementations, each sub-mesh of the polygonal mesh 300 is simplified individually to generate the LOD 500. The LOD 500 can be used for graphics operations, such as rendering operations, to reduce a resource cost, where, for the case of mesh simplification, a smaller number of polygons in the mesh corresponds to a smaller resource cost. Using LOD 500 for graphics operations allows the polygonal mesh corresponding to the LOD 500 to be stored using less space and may allow a computing device to render the polygonal mesh more easily and may allow a computing device to use fewer computing resources (e.g., using less processing power, less memory, etc.) when rendering the polygonal mesh or to perform shadowing. As a result, the LOD 500 is less expensive to store, process, render, etc. As used herein, the term “resource cost” is used to refer to the cost of computing resources in terms of storage, processing, rendering, etc.

### Mesh Simplification

According to various embodiments, mesh simplification includes iteratively applying one or more simplification operators to a mesh. Each application of a simplification operator reduces the topological complexity of the mesh. Some embodiments apply an edge collapse operator, which collapses an edge of the mesh to a single vertex, as shown in FIG. 6.

In FIG. 6, an edge 602 of a mesh connects two vertices labelled v0 and v1. Collapsing the edge 602 replaces it with just a single collapse vertex, notionally picked arbitrarily from the two—in this case v0. The retained vertex v0 is moved to a new location called the collapse point.

To better preserve the regularity of quad meshes, some embodiments use a generalization called polychord collapse, in which multiple edges are collapsed together, in a single operation, as shown in FIG. 7.

In some embodiments of polychord collapse, edges are chosen to neatly collapse entire quad strips (i.e., sequences of quad faces connected by shared edges) or sometimes shorter sequences of quad faces within longer strips. The sets of edges collapsed are those that separate the collapsed quads.

FIG. 7 illustrates a mesh with edge 702 (connecting vertices v3 and v4), edge 704 (connecting vertices v2 and v5), edge 706 (connecting vertices v1 and v6), and edge 708 (connecting vertices v0 and v7). Edges 702, 704, 706, 708 of a quad strip (terminated by triangles) constitute a polychord. Collapsing the polychord includes collapsing all of its edges 702, 704, 706, 708, in a single operation, as shown in FIG. 7.

In some embodiments, where quad strips self-intersect, multiple edges in the set can be connected by shared vertices. Where this happens, some embodiments identify “islands” of connected edges. In general, an island is a subset of the edges in a polychord that share vertices-often each island is just a single edge. Each identified island of edges can be collapsed to a single collapse vertex located at a point in space called the collapse point of that island.

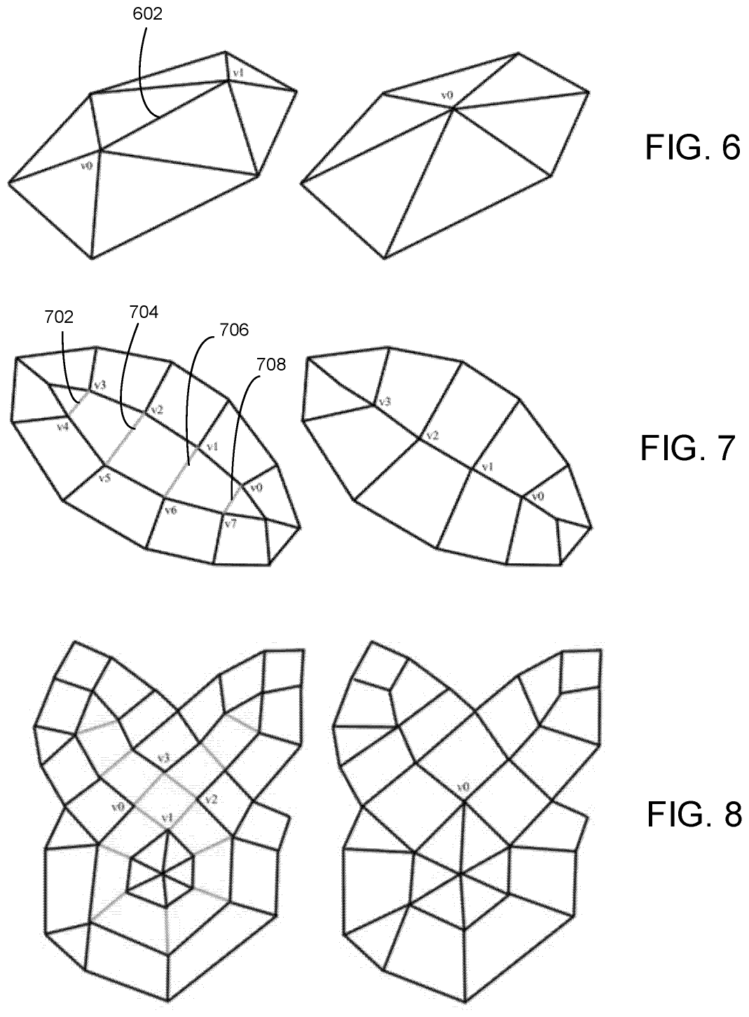

FIG. 8 illustrates a self-intersecting polychord, in one embodiment. In FIG. 8, the polychord self-intersects (crosses itself), with the result that edges (v0, v1), (v1, v2), (v2, v3), and (v3, v0) are connected at vertices v0, v1, v2 and v3, forming a non-trivial island. The entire island can be collapsed to a single collapse vertex, picked from among the island vertices—in this case v0. The collapse point is chosen to optimize the geometric fidelity of the collapsed geometry to the original.

The purpose of edge collapse is to reduce the topological complexity of the mesh by collapsing the faces incident to each collapsed edge. In that sense, edge collapse is a topological operation. Still, it is both influenced by the geometry of the mesh, and optimized to best preserve that geometry. Edge collapse operations choose carefully which edge/polychord to collapse next, selecting the edge/polychord that optimizes the least impact on the fidelity of the mesh with a greater reduction in the complexity of the mesh (e.g., number of triangles). When collapsing an edge/polychord, some embodiments choose carefully the collapse points of the collapse vertices that replace the islands of collapsed edges, picking points which best preserve the local shape of the mesh.

Some embodiments for edge collapse use a technique based on a mathematical construct called a quadric. A quadric is a quadric equation that in 3D can be represented efficiently by a matrix, a vector, and a scalar. Such a quadric is associated with each vertex of the mesh. The quadric stored with each vertex can be thought of as remembering a set of planes, weighted by area or importance, on which the vertex should ideally lie. From the quadric associated with a vertex, some embodiments can compute both a cost metric estimating the geometric infidelity of any arbitrary candidate location for the vertex, and an optimal location for the vertex.

Initially, the quadric associated with each vertex is just the combination of the planes of the faces incident to that vertex. Naturally the location of the vertex satisfies this initial quadric optimally, with a cost of zero.

When considering the collapse of an island of connected edges, some embodiments sum the quadrics associated with the vertices of the island. Summing quadrics can be thought of as combining the sets of planes remembered by the respective quadrics. From this summed quadric, some embodiments can compute an optimal location, or collapse point, for the single collapse vertex that would replace the island after collapse. Then some embodiments query the quadric to estimate the cost of that proposed collapse point. Typically this cost is non-zero, since a single vertex generally cannot optimally satisfy all of the planes in the combined set.

Some embodiments have the option of proposing a different collapse point—to satisfy some other requirement—and evaluating the cost of this new point instead. Some embodiments use this approach, in particular, to smooth collapse points so that the edges of the collapsed mesh still form smooth edge loops.

In some embodiments, the available polychord collapse candidates are stored in a priority queue, and the queue is used to drive iterative simplification. The candidates are prioritized by descending “value,” where the value of a candidate is the ratio of its benefit (for example, number of triangles removed from the mesh) to its cost (for example, the sums of the predicted quadric costs of the islands of connected collapse edges representing a change in geometric fidelity).

In some embodiments, candidate collapses may be rejected if they are found to be unsuitable for one reason or another. Some collapses may be topologically degenerate, in the sense that performing them would collapse two edges on different sides of the mesh, making the merged edge no longer locally two-manifold.

Other candidate collapses that may be rejected are those that may be geometrically degenerate, or simply undesirable, because their proposed collapse points would invert faces of the mesh or make some previously convex faces concave. Such geometrically undesirable collapses can either be rejected outright or penalized in the cost metric. Some embodiments use a variety of different cost terms to penalize different kinds of undesirable collapses. In some embodiments, a total cost metric for a collapse is a sum of the various cost terms.

To perform simplification, some embodiments repeatedly pick the available collapse candidate at the front of the queue, i.e., the collapse with greatest value, and execute the collapse. This consists of collapsing each of the islands of connected edges to just its collapse vertex, and moving the collapse vertex to its computed collapse point. When executing a collapse, the candidate collapse queue is updated to remove any candidates that no longer reflect the new state of the mesh, or whose costs may have changed, and then insert any new candidates, with updated cost estimates. This iterative simplification continues, one collapse at a time. The LOD meshes are created by copying out snapshots of the mesh, as their triangle budget thresholds are met. The iteration ends when all LODs have been created, or when the candidate collapse queue is exhausted.

Some embodiments set the quadric of each new collapse vertex to the sum of the quadrics of the vertices of its island. Since summing quadrics can be thought of as combining their remembered sets of planes over the course of successive collapses, the quadric of each collapse vertex can be thought of as remembering a progressively larger area of the original mesh, i.e., the planes of all incident faces of all the vertices that were collapsed to form it.

Some embodiments also update the normals of the faces incident to collapse vertices. The normals around each collapse vertex are re-averaged (summed and re-normalized), being careful to retain any previously existing hard edges (where normals around a vertex differ). Likewise, the UVs of the faces incident to collapse vertices are updated, typically computing new interpolated UV values at the collapse points, but being careful to preserve the locations of any existing UV boundaries (where UVs around a vertex differ).

### Clothing Meshes and LODs

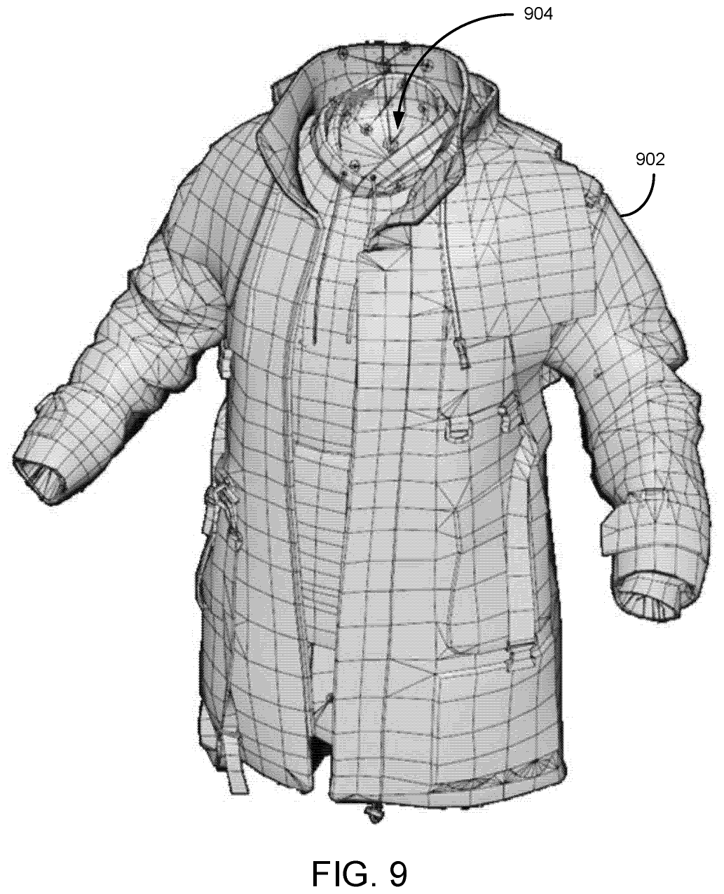

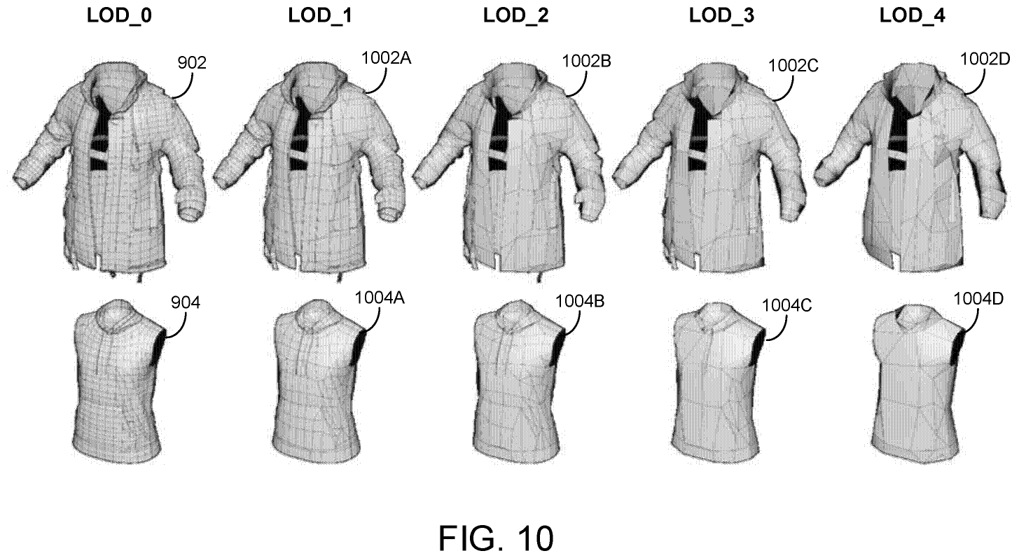

FIG. 9 illustrates clothing meshes, in one embodiment. The example in FIG. 9 shows a jacket mesh 902 and a vest mesh 904. When characters are modelled, their clothing is often modelled separately, often as multiple separate pieces (e.g., t-shirt, jacket, jeans, etc.), and often with multiple versions of each piece. Doing so allows different in-game character looks to be created by mixing the different sub-models in combination. Also, it allows players to build their own custom characters by selecting and mixing the different character and clothing models in-game, in a form of user-generated content. Clothing models are often quite complex, consisting of many independent sub-meshes. For example the buttons, pockets, lapels, and epaulettes of the jacket mesh 902 might be authored as disconnected sub-meshes that overlap in complex ways.

As also shown in FIG. 9, the jacket mesh 902 is layered on top of the vest mesh 904. When artists author clothing objects, the artists define which clothing pieces can be layered on top of which other pieces, and author the models for these pieces such that the pieces are properly layered.

LODs for clothing models can be used during rendering in place of the full-resolution clothing models to save computational complexity, such as when the clothing models are small on screen and/or far away from a camera. LODs are generated for each clothing model separately.

FIG. 10 illustrates LODs of clothing objects, in one embodiment. In FIG. 10, the full-resolution (LOD_0) meshes of the jacket mesh 902 and vest mesh 904 from FIG. 9 are shown. Also shown are LOD levels LOD_1 to LOD_4, where an increasing LOD level refers to a lower-budget LOD. LODs 1002A-1002D represent LODs for the jacket mesh 902, and LODs 1004A-1004D represent LODs for the vest mesh 904.

The authored LODs are then used in combination in-game. This can be true for both player characters (seen by other players in a multiplayer game) and non-player characters (seen by players). For example, when a character is near to a given camera, the rendering engine might use the highest-detail LOD_0 version of the currently selected player body model, and also the LOD_0 versions of the currently selected t-shirt, jacket, and jeans models, when rendering images from that camera.

Then, when the character moves further away from the camera, the rendering engine might switch to the less-detailed (for example, LOD_1) versions of the character model and clothing models, then the even less-detailed (for example, LOD_2) versions of the character model and clothing models, and so on.

When separately authored clothing models are used in combination in game, care should be taken to ensure that the different clothing models work together, geometrically and/or physically. In particular, models that are layered, such as clothing, should not “clip” against (incorrectly overlap) one another. For example, the model of an underlying t-shirt should remain inside the model of an overlaid jacket, and not poke outside through the jacket. If the LOD of the t-shirt poked through the LOD of the overlaid jacket, a visual artifact could be created.

Accordingly, embodiments of the disclosure provide a system and method that automatically generates LODs for clothing objects that can be layered without clipping.

In some embodiments, a full-resolution (LOD_0) mesh of a clothing object can be authored by an artist. In some implementations, the artist also authors an inner bound mesh and an outer bound mesh for the clothing object.

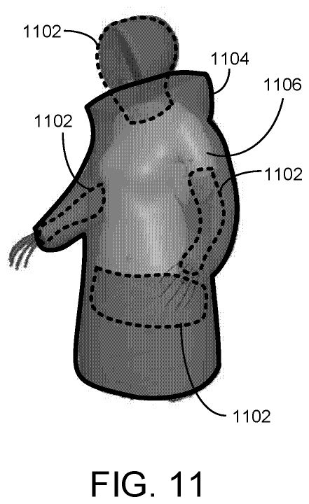

FIG. 11 illustrates an inner bound mesh 1102 and an outer bound mesh 1104 for a t-shirt object 1106, according to one embodiment. Each of the inner bound mesh 1102 and the outer bound mesh 1104 is a closed mesh with no openings. Each vertex of the t-shirt object 1106 is outside the bounds of the inner bound mesh 1102, and each vertex of the t-shirt object 1106 is also inside the bounds of the outer bound mesh 1104.

In some embodiments, voxelized versions of the inner/outer meshes can be generated in order to perform tests on vertices to determine whether a given vertex of a LOD falls within or outside a bound. In other embodiments, vertex-to-mesh tests can be performed, however, this type of bound testing is likely to be more computationally complex than checking a vertex against a voxel volume.

In one embodiment, once an inner bound mesh and an outer bound mesh are created for a full-resolution (LOD_0) clothing object, the same inner bound mesh and an outer bound mesh can be used for each LOD of the full-resolution (LOD_0) clothing object. In other embodiments, LODs of the inner bound mesh and the outer bound mesh are created and applied respectively to each LOD of the clothing object.

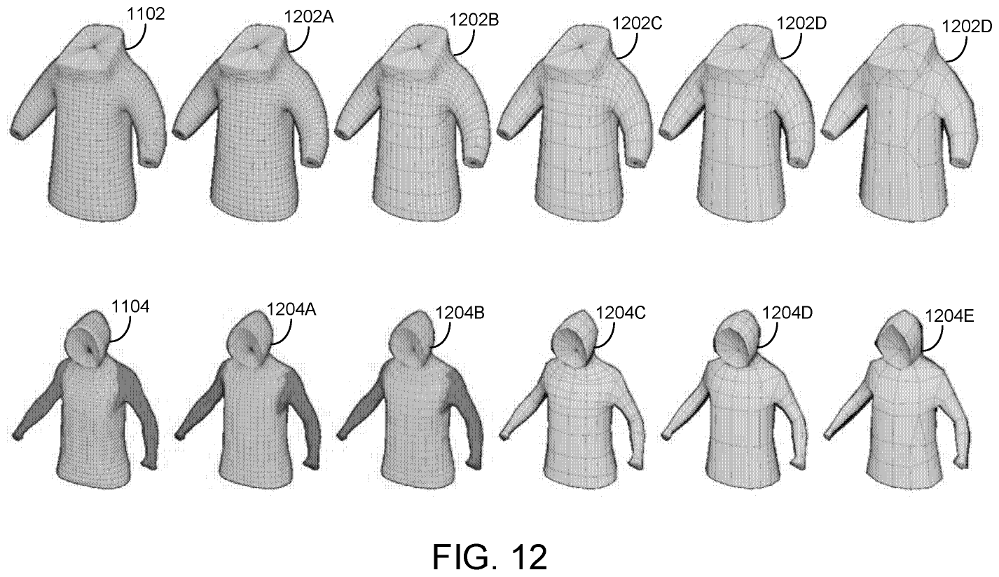

FIG. 12 is an example of LODs of an inner bound mesh and an outer bound mesh, in one embodiment. In FIG. 12, the inner bound mesh 1102 and outer bound mesh 1104 from FIG. 11 are illustrated. Also shown are LODs 1202A-1202E for the inner bound mesh 1102, and LODs 1204A-1204E for the outer bound mesh 1104. In some embodiments that use LODs for the inner bound mesh and the outer bound mesh, when a LOD of the clothing object (for example, LOD_2 of the clothing object) is used in the scene, then the corresponding LOD level LODs of the inner bound mesh and the outer bound mesh are also used.

As described above, since the inner and outer bound meshes are closed meshes, the meshes can be voxelized using known techniques.

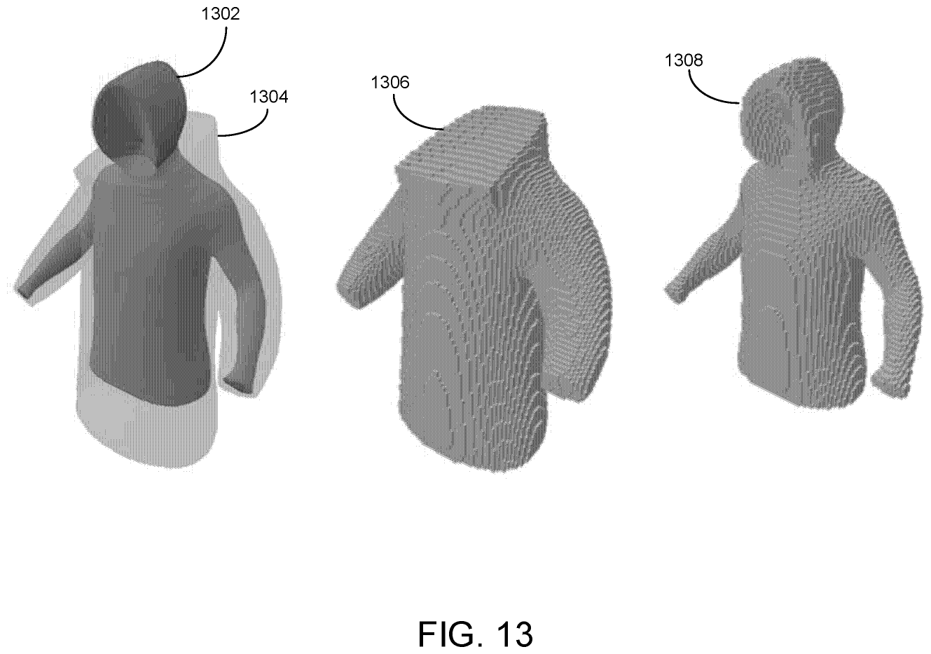

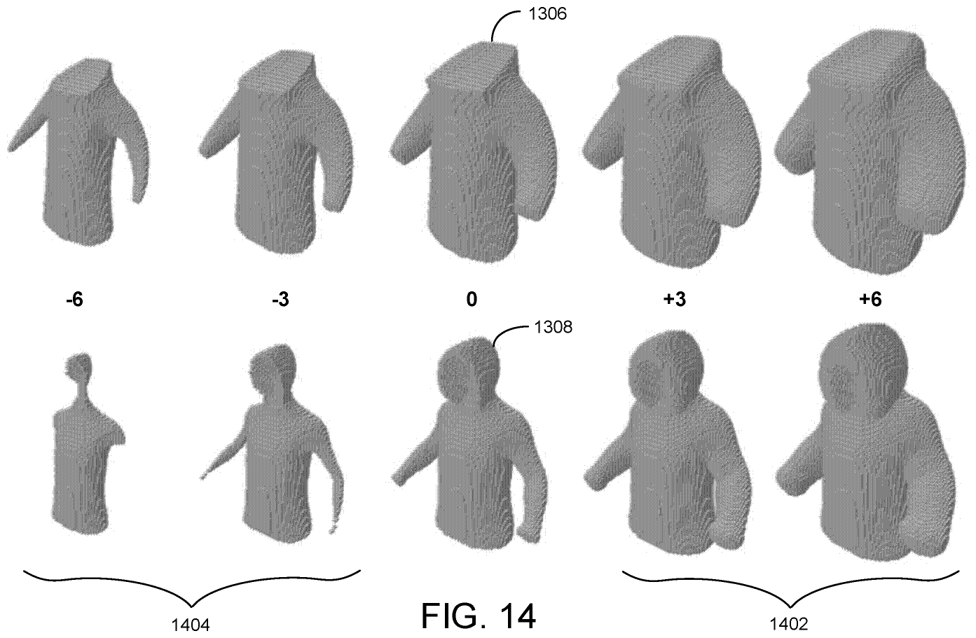

FIG. 13 illustrates voxelized versions of an inner bound mesh 1302 and an outer bound mesh 1304, in some embodiments. For example, a t-shirt object is associated with inner bound mesh 1302 and outer bound mesh 1304. The outer bound mesh 1304 can be voxelized, resulting in voxel volume 1306. The inner bound mesh 1302 can be voxelized, resulting in voxel volume 1308. In one embodiment, the voxel volumes 1304, 1306 can be used to perform tests on vertices to determine whether a vertex of a LOD falls inside or outside a given bound.

According to various embodiments, to generate a LOD for a clothing object, a mesh simplification operation can be performed using any mesh simplification technique to bring the triangle count of the LOD down to the desired triangle budget for that LOD level. Then, as a post-processing step, the vertices of the generated LOD can be checked against the inner and outer bounds to determine whether any vertices of the generated LOD are out of bounds (i.e., not outside the inner bound, or not inside the outer bound). If a vertex of the generated LOD is out of bounds, the vertex is moved to the bound, as described in greater detail herein. In some embodiments, other vertices (which may already be within the bounds) can also be moved.

FIG. 14 is a conceptual diagram illustrating signed distance fields (SDFs) for a voxelized outer bound mesh and a voxelized inner bound mesh, according to one embodiment. The voxel volume 1306 representing an outer bound mesh 1304 and the voxel volume 1308 representing an inner bound mesh 1302 from FIG. 13 are shown again in FIG. 14.

Also shown in FIG. 14 are voxelized versions of signed distance field (SDFs) representing a signed distance of a 3D grid of cubic voxel elements from the surface of the bound. Voxels at the surface of voxel volume 1306 (representing an outer bound mesh) and at the surface of the voxel volume 1308 (representing an inner bound mesh) have distance zero. Voxels outside have positive distances, shown as the voxel representations 1402 in FIG. 14 at a distance of +3 and +6 voxels from the surface of voxel volumes 1306, 1308. Voxels inside have negative distances, shown as the voxel representations 1404 in FIG. 14 at a distance of −3 and −6 voxels from the surface of voxel volumes 1306, 1308.

Using these signed distance fields, embodiments of the disclosure can tell whether a given vertex is inside or outside each bound mesh and by how much. By computing the gradient of the SDFs, embodiments of the disclosure can also tell which direction to move a vertex to move it inside or outside a particular bound.

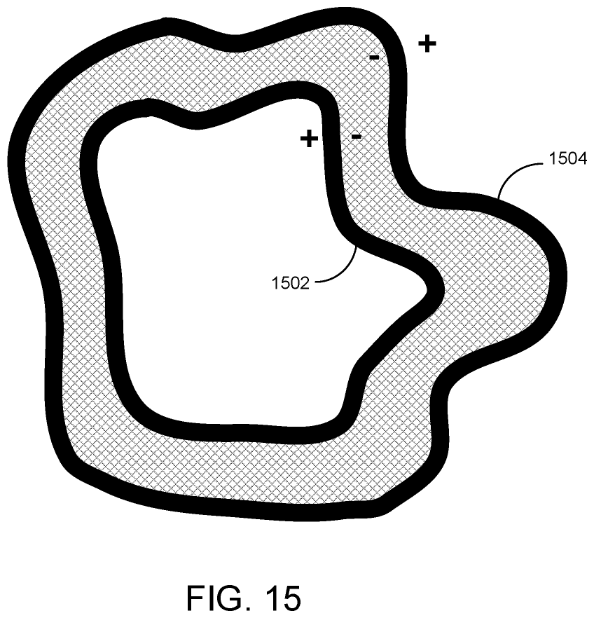

FIG. 15 is a conceptual diagram illustrating a cross-section of an inner bound mesh 1502 and an outer bound mesh 1504, in one embodiment. As shown, for the outer bound mesh 1504, a positive distance (represented by “+” in FIG. 15) for a vertex indicates that the vertex is outside the outer bound mesh 1504 (when should be constrained to being inside the outer bound mesh 1504), and a negative distance (represented by “−” in FIG. 15) for a vertex indicates that the vertex is inside the outer bound mesh 1504 (where it should be).

In one implementation, the notation for the inner bound mesh 1502 is reversed.

Namely, for the inner bound mesh 1502, a positive distance (represented by “+” in FIG. 15) for a vertex indicates that the vertex is outside the inner bound mesh 1502 (when it should be constrained to being inside the inner bound mesh 1502), and a negative distance (represented by “−” in FIG. 15) for a vertex indicates that the vertex is inside the inside bound mesh 1502 (where it should be). Using opposite +/− notations for outer and inner bound meshes in this manner makes it such that, relative to a given bound mesh, if the directionality of the distance to the given bound mesh is a positive number, then the vertex should be moved to be constrained to the bound. If the directionality of the distance to the given bound mesh is zero or a negative number, then the vertex is properly located with respect to the given bound mesh.

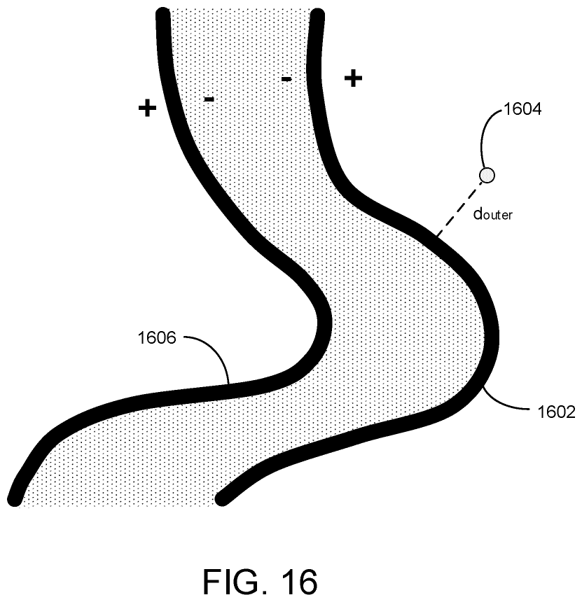

FIG. 16 illustrates an example of a vertex 1604 outside an outer bound mesh 1602 that should be moved to the bound, according to one embodiment. Inner bound mesh 1606 and outer bound mesh 1602 are shown. When a LOD is generated, vertex 1604 is generated for the LOD (i.e., based on edge collapse operations). Using the signed distance field, embodiments of the disclosure can look up the signed distance “dₒᵤₜₑᵣ” to the outer bound mesh for vertex 1604, which is a positive value in the example shown. Similarly, embodiments of the disclosure can look up the distance “dᵢₙₙₑᵣ” to the inner bound mesh 1606 for vertex 1604, which is negative value in the example shown.

Some embodiments also compute a gradient (g) for vertex 1604 relative to each bound. In one implementation, the gradient can be computed using a Sobel kernel. The Sobel kernel uses 3×3 kernels that are convolved with the grid cell of the vertex to generate a gradient vector for the vertex:

$${h}_{z}^{′} ( : , : , - 1 ) = [ \begin{matrix}+ 1 & + 2 & + 1 \\ + 2 & + 4 & + 2 \\ + 1 & + 2 & + 1\end{matrix} ]$$

$${h}_{z}^{′} ( : , : , 0 ) = [ \begin{matrix}0 & 0 & 0 \\ 0 & 0 & 0 \\ 0 & 0 & 0\end{matrix} ]$$

$${h}_{z}^{′} ( : , : , 1 ) = [ \begin{matrix}- 1 & - 2 & - 1 \\ - 2 & - 4 & - 2 \\ - 1 & - 2 & - 1\end{matrix} ]$$

The equation above shows only the z values of the kernel, as an example. The cells of the kernel are vectors, and the other coordinates are assigned similarly using similar equations. In effect, in each coordinate there are positive values on one side and negative values on the other.

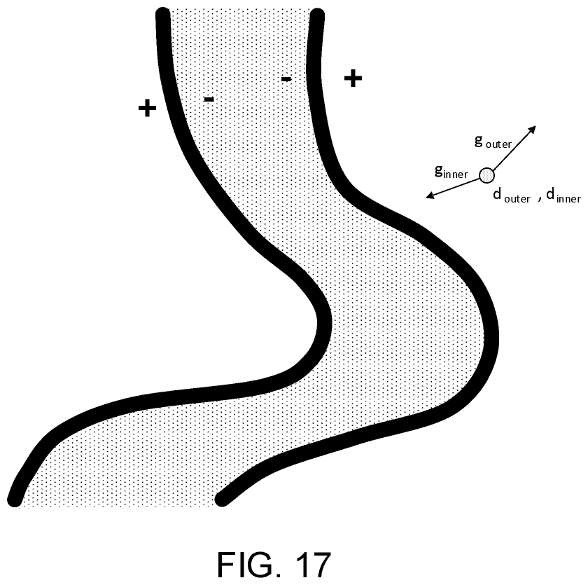

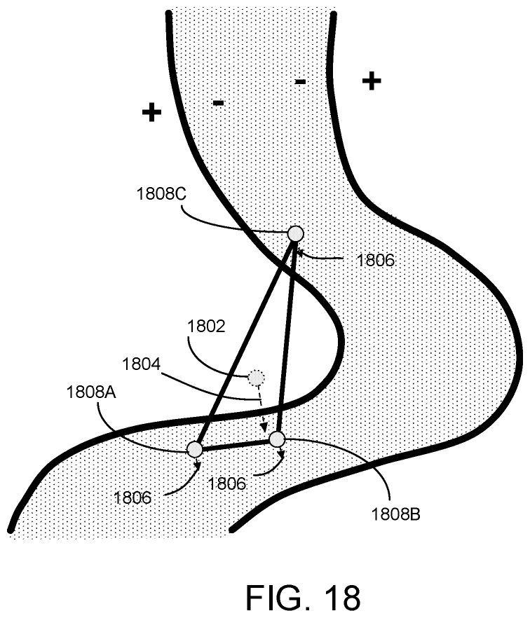

FIG. 17 illustrates computed values for a vertex relative to an outer bound mesh and an inner bound mesh, in one embodiment. In the example shown, a signed distance to the outer bound mesh is designated dₒᵤₜₑᵣ, and a signed distance to the inner bound mesh is designated dᵢₙₙₑᵣ. Also shown is a gradient vector for the vertex relative to the outer bound mesh designated gₒᵤₜₑᵣ, and a gradient vector for the vertex relative to the inner bound mesh designated gᵢₙₙₑᵣ.

In one implementation, the gradient vector, if pointing away from a bound mesh, indicates that the vertex is outside the bound. The gradient vector can, likewise, be used to identify the direction towards the bound mesh, for example, by identifying the negative/opposite direction of the gradient vector.

Once distance values dₒᵤₜₑᵣ and dᵢₙₙₑᵣ and gradient vectors gₒᵤₜₑᵣ and gᵢₙₙₑᵣ are calculated, embodiments of the disclosure can compute bound vectors (b), using the following equations:

$${b}_{outer} = - max ( {d}_{outer} , 0 ) * {g}_{outer}$$

$${b}_{inner} = - max ( {d}_{inner} , 0 ) * {g}_{inner}$$

The bound vectors define a direction to move a vertex to be within a respective bound, and by how much it should be moved.

In one embodiment, the vertex can be moved according to the bound vector to be within the respective bound.

In another embodiment, the distance that a vertex is moved in one iteration is clamped to a threshold distance and is moved by a distance up to a maximum step size. The values for the bound vectors can then be recomputed again after this step-wise movement of the vertex, and the vertex is moved again in the next iteration. In one implementation, the system stops moving vertices after a maximum number of steps, or when the vertices have stopped moving.

In some embodiments, additional calculations can be performed to move other vertices besides the vertices identified as being outside of respective bounds. For example, the faces of concave meshes can sometimes clip against one another even though their vertices are correctly bounded. As such, some embodiments of the disclosure add additional vectors that try to bound the centers of faces and the midpoints of edges. These vectors (i.e., movement amounts and directions) can be split evenly between the vertices of the respective faces or edges.

FIG. 18 is a conceptual diagram illustrating a vector for moving vertices of a face, according to one embodiment. In one embodiment, for each face of a generated LOD, a center of the face can be calculated, shown as point 1802 in FIG. 18. If the location of point 1802 is outside of the bounds, a bound vector 1804 can be computed for the point 1802 to bound the point 1802 to a bound (for example, an inner bound in FIG. 18) using the techniques described above. The bound vector 1804 can be divided into three vectors 1806 (i.e., where the sum of the three vectors 1806 is equivalent to the bound vector 1804). The vector 1806 can then be applied to each of the vertices 1808A, 1808B, 1808C of the face. In this manner, the movement of the bound vector 1804 is distributed to the vertices of the face.

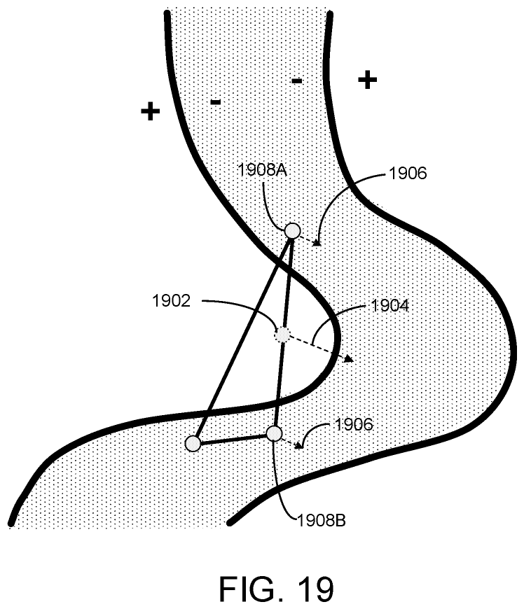

FIG. 19 is a conceptual diagram illustrating a vector for moving vertices of an edge, according to one embodiment. In one embodiment, for each edge of a generated LOD, a midpoint of the edge can be calculated, shown as point 1902 in FIG. 19. If the location of point 1902 is outside of the bounds, a bound vector 1904 can be computed for the point 1902 to bound the point 1902 to a bound (for example, an inner bound in FIG. 19) using the techniques described above. The bound vector 1904 can be divided into two vectors 1906 (i.e., where the sum of the two vectors 1906 is equivalent to the bound vector 1904). The vector 1906 can then be applied to each of the vertices 1908A, 1908B of the edge. In this manner, the movement of the bound vector 1904 is distributed to the vertices of the edge.

In some embodiments, for each vertex that is outside the bounds, the movement of the vertex in each step can be based on the bound vector for the vertex, and also the bound vectors for the centers of faces containing the vertex that lie out of bounds and midpoints of edges containing the vertex that lie out of bounds.

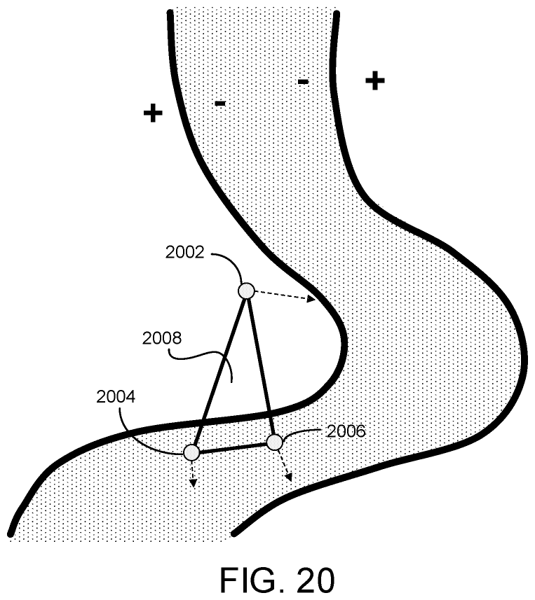

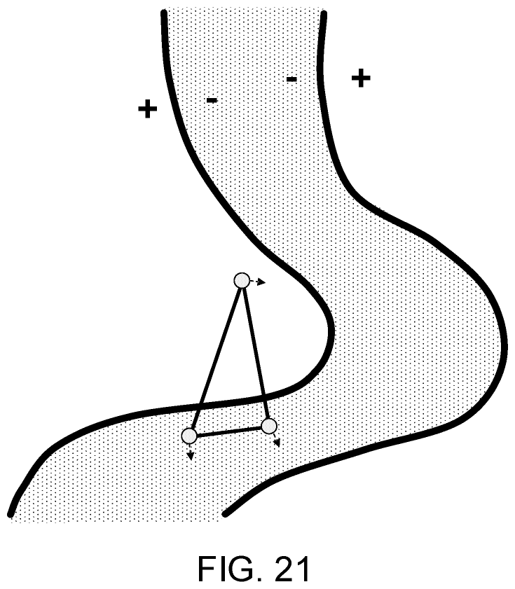

FIG. 20 is a conceptual diagram illustrating aggregating bound vectors to move vertices, in one embodiment. As described above, various contributing bound vectors can be used to move vertices in a generated LOD. For example, a vertex-based bound vector can move a vertex that is outside the bounds. Also, a face-based bound vector can be used to move vertices of a face when a center of the face is outside the bounds. Additionally, an edge-based bound vector can be used to move vertices of an edge when a midpoint of the edge is outside the bounds. FIG. 20 shows vertices 2002, 2004, and 2006 and arrows emanating from each vertex that indicate a direction and magnitude of an aggregate bound vector that can be formed based on combining the above-noted vertex-based, face-based, and/or edge-based bound vectors. Vertex 2002 is moved in the direction of a bound vector based on a bound vector for the vertex (since the vertex is outside a bound) and based on a bound vector for the face 2008 that includes the vertex 2002, and well as bound vectors for the midpoint of edges that connect to vertex 2002 (i.e., the edge connecting vertex 2002 and vertex 2004, and the edge connecting vertex 2002 and vertex 2006). The bound vector for vertex 2002 can also be based on the bound vectors for other faces and edges incident on the vertex (not shown for clarity). As shown in FIG. 21, the aggregated bound vectors (represented by arrows) for each of vertices 2002, 2004, 2006 is different, represented by varying lengths and directions of the arrows.

FIG. 21 is a conceptual diagram illustrating the bound vectors to move vertices in one time step, in one embodiment. As described above, the vertices are moved in one time step along their bound vectors up a maximum distance. The direction of the bound vectors in FIG. 21 are the same as the directions of the bound vectors shown in FIG. 20, except the vectors in FIG. 21 are shorter, representing the maximum distance that the respective vertices are moved in the direction of their respective bound vectors in one iteration. After the vertices are moved, the disclosed system and method recalculates the bound vectors for the vertices at the updated locations. This way the LOD mesh is moved incrementally towards the bound so as not to introduce artifacts.

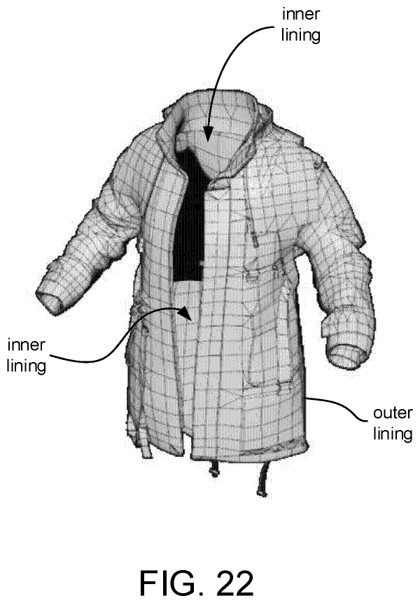

In some embodiments, when clothing objects are modeled, the clothing objects may be associated with an outer lining and an inner lining. For example, referring the jacket mesh shown in FIG. 22, the jacket has an outer lining made up of polygonal faces, but also an inner lining on the inside of the clothing object made up of polygonal faces. In some implementations, the inner lining is nearly coincident with the outer lining, but is separated slightly by a small distance.

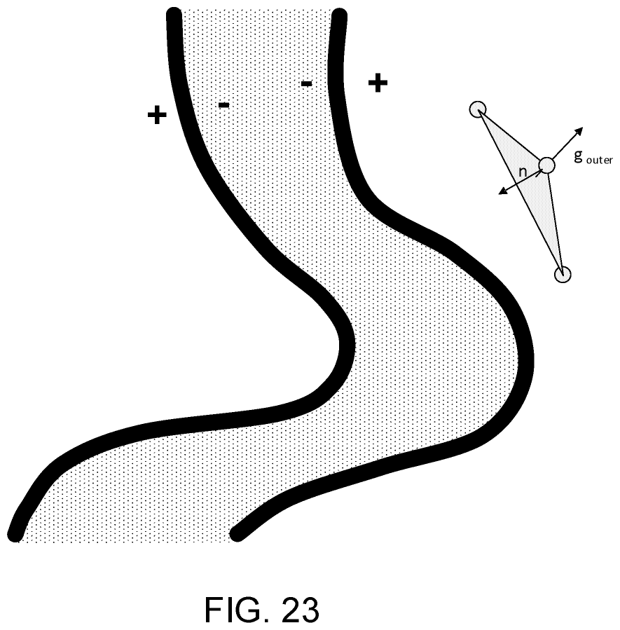

In some embodiments, for a LOD generated for a clothing object, a vertex of the LOD can be identified as being on the inner lining of a clothing object if a surface normal for the vertex is in the opposite direction of the gradient vector for the vertex relative to the outer bound mesh (gₒᵤₜₑᵣ), as shown in FIG. 23. If a vertex is identified as being on the inner lining, the vertex can be considered “unbounded,” meaning that the vertex is not constrained to the inner and outer bound meshes and can lie outside the bounds. This is done to prevent, for example, an inner lining surface to be constrained to lie outside of an outer lining surface, which could introduce an artifact.

Still further, some embodiments use a smoothing operator to further adjust the locations of the vertices in the generated LODs.

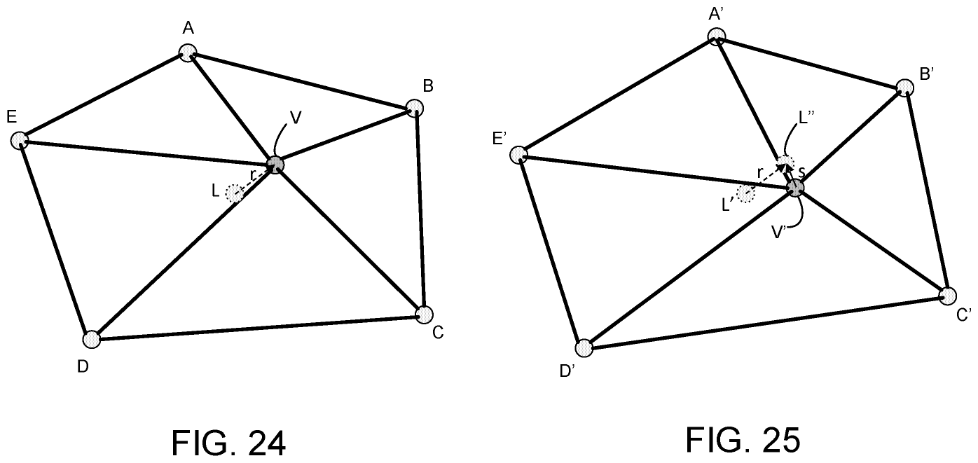

FIG. 24 illustrates a polygonal mesh illustrating a vertex V that is connected by edges to vertices A, B, C, D, E. The vertices shown in FIG. 24 may be vertices of a generated LOD. In one embodiment, a center of the polygon formed by the vertices A, B, C, D, E that are connected to vertex V can be computed. This is shown as location L in FIG. 24. A vector “r” between the location L and a location of the vertex V is calculated. Vector r represents a position of vertex V relative to its neighbors.

In some embodiments, after the various vertices have been moved in a given time step towards a bound, the vertex locations can be adjusted to maintain their relative positions.

FIG. 25 illustrates a polygonal mesh illustrating a vertex V′ that is connected by edges to vertices A′, B′, C′, D′, E′. The example in FIG. 25 illustrates updated locations of the vertices in FIG. 24 after being moved in one time step by bounding vectors, as described herein.

A center of the polygon formed by the vertices A′, B′, C′, D′, E′ that are connected to vertex V′ can be computed. This is shown as location L′ in FIG. 25. The vector “r” computed in FIG. 24 is then applied to the location L′, which results in location L″. A vector “s” is computed that translates the location of the vertex V′ to location L″. The vector “s” can then be combined with the other bound vectors discussed above when computing an aggregate movement direction for the vertex in the next time step.

In some implementations, a particular problem with generating LODs for clothing objects occurs at openings, such as necks, hems, and sleeves. Artists sometimes prefer to model clothing objects as a closed mesh, so where the openings of a clothing piece are formed, the openings can be capped with a series of additional polygons.

In some embodiments, the smoothing operation shown in FIGS. 24-25 is discarded and not used for a given vertex if the smoothing operation would increase the error of the vertex with respect to any bound.

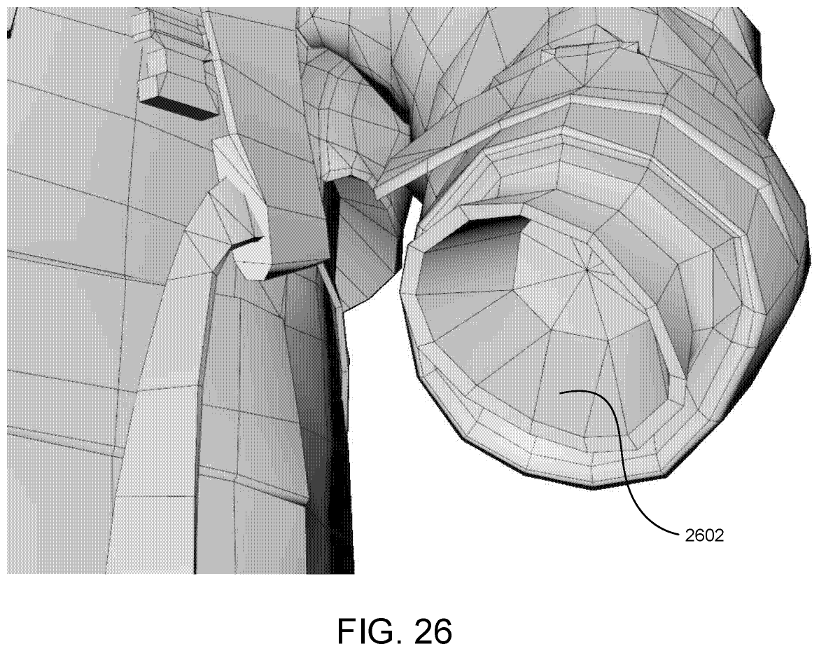

FIG. 26 is an example of a cap 2602 of an open sleeve of a clothing object, in one embodiment. The cap 2602 causes a problem with the inner bound mesh for the clothing object, as the vertices of the cap 1602 could fall within the inner bound mesh for the clothing object. As a result, the bounds would sometimes themselves clip the meshes they supposedly bound.

Where this occurs, vectors computed to move the vertices of the cap 2602 outside the bound are ineffective. No amount of lateral movement can free the vertices, and instead they would need to be moved down and off the end of the bound. This over-constrained situation results in jagged geometry where the vertices are pushed to-and-fro against the bounds.

Some embodiments of the disclosure solve this problem using the texture map for the clothing object.

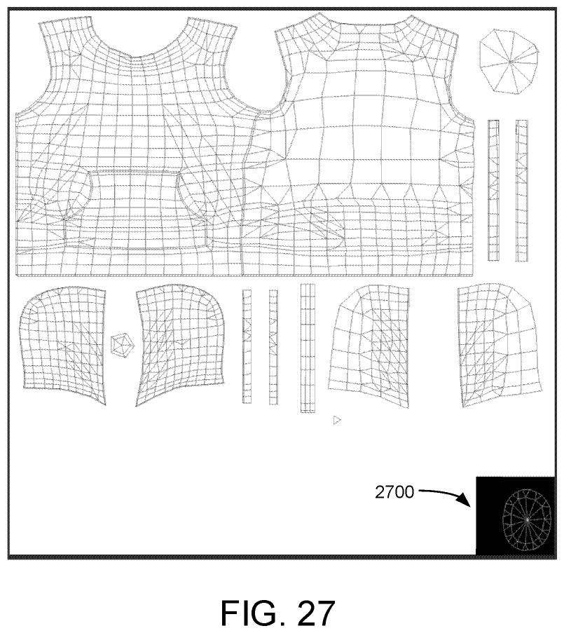

FIG. 27 is an example of a texture map for a vest object, in one embodiment. The texture map includes a series of UV islands that map a texture to different sub-meshes of the vest object. Also shown in FIG. 27 is a reserved space 2700 of the texture map that includes a UV island reserved for marking capped openings. When artists mark different portions of a clothing object as mapping to a particular UV island in the texture map, the artists can mark the cap faces at openings of the clothing object to map to special UV values (texture coordinates) from the reserved space 2700. Accordingly, the LOD generation system can treat the vertices of any faces with UVs in the reserved space 2700 as unboundable and not attempt to bound them (i.e., their bound vectors are nulled).

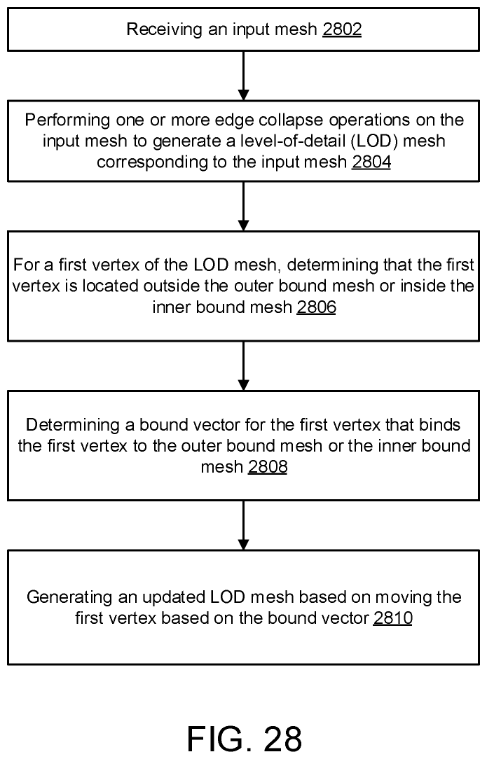

FIG. 28 is a flow diagram of method steps for generating a simplified mesh, according to one embodiment. In various implementations, the method can be performed by the processor 110, the graphics processor 116, or a combination of the processor 110 and the graphics processor 116. In some embodiments, two or more steps shown in FIG. 28 may be performed by the same process or at the same time or in a different order.

As shown, the method begins at step 2802, where the processor receives an input mesh. The input mesh may be a polygonal mesh representing a clothing object. The input mesh is associated with an outer bound mesh and an inner bound mesh, where each vertex of the input mesh is located in a space between the outer bound mesh and the inner bound mesh.

At step 2804, the processor performs one or more edge collapse operations on the input mesh to generate a level-of-detail (LOD) mesh corresponding to the input mesh. Various techniques for generating LODs are known to reduce an input mesh to a designated triangle budget for the LOD.

At step 2806, for a first vertex of the LOD mesh, the processor determines that the first vertex is located outside the outer bound mesh or inside the inner bound mesh.

In one embodiment, determining that the first vertex is located outside the outer bound mesh or inside the inner bound mesh is based on voxel volumes. A first voxel volume is generated representing the outer bound mesh, and a second voxel volume is generated representing the inner bound mesh. Determining that the first vertex is located outside the outer bound mesh or inside the inner bound mesh is based on determining that a location of the first vertex is outside the first voxel volume or inside the second voxel volume.

At step 2808, the processor determines a bound vector for the first vertex that binds the first vertex to the outer bound mesh (if the vertex is outside the outer bound mesh) or the inner bound mesh (if the vertex is inside the inner bound mesh).

In one embodiment, determining the bound vector for the first vertex comprises computing a gradient vector that defines a distance and a direction to move the first vertex to the bound that is violated. The gradient vector may be based on a signed distance field representing a distance of the first vertex to each of the first voxel volume representing the outer bound mesh and the second voxel volume representing the inner bound mesh.

At step 2810, the processor generates an updated LOD mesh based on moving the first vertex based on the bound vector. In one embodiment, the first vertex in the updated LOD mesh is located inside the outer bound mesh and outside the inner bound mesh. In some embodiments, the vertex is moved in the direction of the bound vector up to a maximum distance in one iteration. The method in FIG. 28 is then performed again on the updated LOD with the updated locations of the vertices to iteratively move the vertices to the bounds.

In some embodiments, the method in FIG. 28 can be repeated for each vertex that lies outside the outer bound mesh or inside the inner bound mesh. In some embodiments, certain vertices can be left unbounded (i.e., left to be outside the outer bound mesh or inside the inner bound mesh), such as when the input object represents a clothing object, and the vertex is a vertex on an inner lining of the input mesh or is a vertex of a cap on the clothing object that closes an opening on the clothing object.

In some embodiments, additional bound vectors can be computed for faces and edges of the LOD mesh.

In one implementation for faces, for each face of the LOD mesh, a center of the face is calculated. If the center of the face is located outside the outer bound mesh or inside the inner bound mesh, an additional bound vector is generated that would bind the center of the face to the bound. The additional bound vector can be distributed to each vertex that includes the face.

In one implementation for edges, for each edge of the LOD mesh, a midpoint of the edge is calculated. If the midpoint of the edge is located outside the outer bound mesh or inside the inner bound mesh, an additional bound vector is generated that would bind the midpoint of the edge to the bound. The additional bound vector can be distributed to each vertex that includes the edge.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for generating a simplified mesh, the method comprising:
receiving, by one or more processors, an input mesh, wherein the input mesh is a polygonal mesh, wherein the input mesh is associated with an outer bound mesh and an inner bound mesh, wherein each vertex of the input mesh is located inside the outer bound mesh and outside the inner bound mesh;
performing, by the one or more processors, one or more mesh simplifications operations on the input mesh to generate a level-of-detail (LOD) mesh corresponding to the input mesh;
for a first vertex of the LOD mesh, determining, by the one or more processors, that the first vertex is located outside the outer bound mesh or inside the inner bound mesh;
determining, by the one or more processors, a bound vector for the first vertex that binds the first vertex to the outer bound mesh when the first vertex is located outside the outer bound mesh or binds the first vertex to the inner bound mesh when the first vertex is located inside the inner bound mesh; and
generating, by the one or more processors, an updated LOD mesh based on moving the first vertex based on the bound vector, wherein the first vertex in the updated LOD mesh is located inside the outer bound mesh and outside the inner bound mesh.

2. The method according to claim 1, wherein the input mesh comprises a clothing object.

3. The method according to claim 1, further comprising:
generating a first voxel volume representing the outer bound mesh; and
generating a second voxel volume representing the inner bound mesh;
wherein determining that the first vertex is located outside the outer bound mesh or inside the inner bound mesh is based on determining that a location of the first vertex is outside the first voxel volume or inside the second voxel volume.

4. The method according to claim 1, wherein determining the bound vector for the first vertex comprises:
computing a gradient vector that defines a distance and a direction to move the first vertex to lie inside the outer bound mesh or outside the inner bound mesh.

5. The method according to claim 1, wherein generating the updated LOD mesh is based on moving a second vertex based on a second bound vector.

6. The method according to claim 5, wherein moving the second vertex based on the second bound vector comprises:
determining a center of a face that includes the second vertex;
determining that the center of the face is located outside the outer bound mesh or inside the inner bound mesh; and
determining a third bound vector for the face that binds the center of the face to the outer bound mesh when the center of the face is located outside the outer bound mesh or binds the center of the face to the inner bound mesh when the center of the face is located inside the inner bound mesh, wherein the second bound vector is based on the third bound vector.

7. The method according to claim 5, wherein moving the second vertex based on the second bound vector comprises:
determining a midpoint of an edge that includes the second vertex;
determining that the midpoint of the edge is located outside the outer bound mesh or inside the inner bound mesh; and
determining a third bound vector for the edge that binds the midpoint of the edge to the outer bound mesh when the midpoint of the edge is located outside the outer bound mesh or binds the midpoint of the edge to the inner bound mesh when the midpoint of the edge is located inside the inner bound mesh, wherein the second bound vector is based on the third bound vector.

8. The method according to claim 1,
wherein the input mesh represents a clothing object, wherein the input mesh includes an inner lining and an outer lining;
wherein a second vertex in the updated LOD remains unbounded and lies outside the outer bound mesh or inside the inner bound mesh; and
wherein the second vertex is a vertex on the inner lining of the input mesh or is a vertex of a cap on the clothing object that closes an opening on the clothing object.

9. A non-transitory computer-readable storage medium storing instructions that, when executed by one or more processors, causes a computing device to generate a simplified mesh, by performing operations comprising:
receiving an input mesh, wherein the input mesh is a polygonal mesh, wherein the input mesh is associated with an outer bound mesh and an inner bound mesh, wherein each vertex of the input mesh is located inside the outer bound mesh and outside the inner bound mesh;
performing one or more mesh simplification operations on the input mesh to generate a level-of-detail (LOD) mesh corresponding to the input mesh;
for a first vertex of the LOD mesh, determining that the first vertex is located outside the outer bound mesh or inside the inner bound mesh;
determining a bound vector for the first vertex that binds the first vertex to the outer bound mesh when the first vertex is located outside the outer bound mesh or binds the first vertex to the inner bound mesh when the first vertex is located inside the inner bound mesh; and
generating an updated LOD mesh based on moving the first vertex based on the bound vector, wherein the first vertex in the updated LOD mesh is located inside the outer bound mesh and outside the inner bound mesh.

10. The computer-readable storage medium according to claim 9, wherein the input mesh comprises a clothing object.

11. The computer-readable storage medium according to claim 9, the operations further comprising:
generating a first voxel volume representing the outer bound mesh; and
generating a second voxel volume representing the inner bound mesh;
wherein determining that the first vertex is located outside the outer bound mesh or inside the inner bound mesh is based on determining that a location of the first vertex is outside the first voxel volume or inside the second voxel volume.

12. The computer-readable storage medium according to claim 9, wherein determining the bound vector for the first vertex comprises:
computing a gradient vector that defines a distance and a direction to move the first vertex to lie inside the outer bound mesh or outside the inner bound mesh.

13. The computer-readable storage medium according to claim 9, wherein generating the updated LOD mesh is based on moving a second vertex based on a second bound vector.

14. The computer-readable storage medium according to claim 13, wherein moving the second vertex based on the second bound vector comprises:
determining a center of a face that includes the second vertex;
determining that the center of the face is located outside the outer bound mesh or inside the inner bound mesh; and
determining a third bound vector for the face that binds the center of the face to the outer bound mesh when the center of the face is located outside the outer bound mesh or binds the center of the face to the inner bound mesh when the center of the face is located inside the inner bound mesh, wherein the second bound vector is based on the third bound vector.

15. The computer-readable storage medium according to claim 13, wherein moving the second vertex based on the second bound vector comprises:
determining a midpoint of an edge that includes the second vertex;
determining that the midpoint of the edge is located outside the outer bound mesh or inside the inner bound mesh; and
determining a third bound vector for the edge that binds the midpoint of the edge to the outer bound mesh when the midpoint of the edge is located outside the outer bound mesh or binds the midpoint of the edge to the inner bound mesh when the midpoint of the edge is located inside the inner bound mesh, wherein the second bound vector is based on the third bound vector.

16. The computer-readable storage medium according to claim 9,
wherein the input mesh represents a clothing object, wherein the input mesh includes an inner lining and an outer lining;
wherein a second vertex in the updated LOD remains unbounded and lies outside the outer bound mesh or inside the inner bound mesh; and
wherein the second vertex is a vertex on the inner lining of the input mesh or is a vertex of a cap on the clothing object that closes an opening on the clothing object.

17. A device for generating a simplified mesh, the device comprising:
a memory storing instructions; and
one or more processors configured to the execute the instructions to cause the device to:
receive an input mesh, wherein the input mesh is a polygonal mesh, wherein the input mesh is associated with an outer bound mesh and an inner bound mesh, wherein each vertex of the input mesh is located inside the outer bound mesh and outside the inner bound mesh;
perform one or more mesh simplification operations on the input mesh to generate a level-of-detail (LOD) mesh corresponding to the input mesh;
for a first vertex of the LOD mesh, determine that the first vertex is located outside the outer bound mesh or inside the inner bound mesh;
determine a bound vector for the first vertex that binds the first vertex to the outer bound mesh when the first vertex is located outside the outer bound mesh or binds the first vertex to the inner bound mesh when the first vertex is located inside the inner bound mesh; and
generate an updated LOD mesh based on moving the first vertex based on the bound vector, wherein the first vertex in the updated LOD mesh is located inside the outer bound mesh and outside the inner bound mesh.

18. The device according to claim 17, wherein generating the updated LOD mesh is based on moving a second vertex based on a second bound vector.

19. The device according to claim 18, wherein moving the second vertex based on the second bound vector comprises:
determining a center of a face that includes the second vertex;
determining that the center of the face is located outside the outer bound mesh or inside the inner bound mesh; and
determining a third bound vector for the face that binds the center of the face to the outer bound mesh when the center of the face is located outside the outer bound mesh or binds the center of the face to the inner bound mesh when the center of the face is located inside the inner bound mesh, wherein the second bound vector is based on the third bound vector.

20. The device according to claim 18, wherein moving the second vertex based on the second bound vector comprises:
determining a midpoint of an edge that includes the second vertex;
determining that the midpoint of the edge is located outside the outer bound mesh or inside the inner bound mesh; and
determining a third bound vector for the edge that binds the midpoint of the edge to the outer bound mesh when the midpoint of the edge is located outside the outer bound mesh or binds the midpoint of the edge to the inner bound mesh when the midpoint of the edge is located inside the inner bound mesh, wherein the second bound vector is based on the third bound vector.
